(19) United States
(12) Patent Application Publication
(10) Pub. No.: US 2016/0132876 A1
(43) Pub. Date: May 12, 2016

(54) AUTOMATIC CLOSED LOOP PAYMENT REDEMPTION

(71) Applicant: GOOGLE INC., Mountain View, CA (US)

(72) Inventors: Christopher Petersen, New Canaan, CT (US); Tim Kuchlein, Mountain View, CA (US); Peter Hazlehurst, Foster City, CA (US); Harry Lee Butler, IV, New York, NY (US)

(73) Assignee: GOOGLE INC., Mountain View, CA (US)

(21) Appl. No.: 14/177,969

(22) Filed: Feb. 11, 2014

(51) Int. Cl. G06Q 20/40

(52) U.S. Cl. CPC G06Q 20/40

(57) ABSTRACT

Redeeming closed loop payment instruments in wallet account transactions comprises a payment system server configured to associate financial accounts with a payment account of a user, comprising at least one closed loop account. The server receives, from a card network, a first payment authorization request originating from a merchant, comprising the payment account identifier and a request to fund a transaction. The server communicates, to a closed loop account issuer computing system, a redemption request to redeem funds from the closed loop account. The server receives a redemption of funds from the closed loop account. The server deducts the redeemed funds redeemed from a total amount of funds requested in the first payment authorization request. Upon receiving the funds, the server communicates to the merchant computing system a second authorization for the total amount of funds requested in the first authorization request based on the redemption of funds.

### TECHNICAL FIELD

The present disclosure relates generally to network transactions originated via a payment card, and more particularly to redeem funds from closed loop payment instruments in open loop wallet account transactions.

### BACKGROUND

Wallet accounts on payment processing systems enable users to utilize a single account to access multiple financial accounts maintained by multiple issuers. The user applies the wallet account to a transaction with the merchant in a manner similar to the application of any financial account to a transaction. The payment processing system can select the appropriate financial account to use as the backing account for the transaction. The backing account can be selected based on a set of rules or a selection of the user. The backing accounts are typically open loop payment instruments, such as credit cards, debit cards, or stored value cards. Accordingly, the initial transaction and the backing instrument transactions are typically processed via open loop processing systems.

Conventional wallet account systems, however, do not allow the user to utilize closed loop payment instruments, such as a merchant gift card, as the backing instrument for a transaction that is processed over an open loop processing system, such as a credit card network.

### SUMMARY

Techniques herein provide a computer-implemented method to redeem closed loop payment instruments in wallet account transactions. A payment system employs a server configured for associating a plurality of financial accounts with a payment account of a user, the plurality of financial accounts comprising at least one closed loop account. The server receives, from a card network, a first payment authorization request originating from a merchant computing system, the first payment authorization request comprising the payment account identifier, a request to fund a transaction using the payment account, and an indication of an identity of a merchant associated with the merchant computing system. The server communicates, to a closed loop account issuer computing system associated with the closed loop account associated with the payment account, a redemption request to redeem funds from the closed loop account associated with the payment account in connection with the first payment authorization request, the redemption request comprising information from the first payment authorization request. The server receives a redemption of funds from the closed loop account associated with the payment account, the funds being deducted from the closed loop account. The server deducts the funds redeemed from the closed loop account issuer computing system from a total amount of funds requested in the first payment authorization request to obtain a remaining amount of funds required to fund the transaction. The server identifies a second financial account associated with the payment account to use as a backing financial account for the requested amount of funds required to fund the transaction, the second financial account being the open loop account associated with the payment account and communicates a second payment authorization request comprising a request for the remaining amount of funds required to fund the transaction. Upon receiving the authorization, the server communicates to the merchant computing system a second authorization for the total amount of funds requested in the first authorization request based on the redemption of funds from the closed loop account associated with the payment account and the first authorization for the remaining amount of funds required to fund the transaction from the open loop account associated with the payment account.

In certain other example aspects described herein, a system and a computer program product redeem closed loop payment instruments in wallet account transaction are provided.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for redeeming closed loop payment instruments in wallet account transactions, in accordance with certain example embodiments.

FIG. 2 is a block flow diagram depicting a method to configure payment instruments in a payment account on a payment processing system, in accordance with certain example embodiments.

FIG. 3 is a block flow diagram depicting a method to redeem closed loop payment instruments in wallet account transactions, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

In one example embodiment, a user conducts a transaction at a merchant that is associated with a merchant gift card or other closed loop payment instrument. When a transaction is initiated, the digital wallet application module, or other embodiment of the digital wallet account, accesses the wallet account information residing in the digital wallet application module. When the merchant system transmits the request through the merchant acquirer system and the credit card network (an open loop processing system), the payment processing system recognizes the merchant system. The payment processing system transmits a request to the issuer of gift cards associated with the merchant. The gift card issuer system determines if any gift cards associated with the merchant are in an account of the user. If a gift card is available, the gift card issuer system transmits the redemption of the gift card to the payment processing system. The payment processing system deducts the gift card amount from the transaction total and accesses an alternate payment instrument for the remainder of the transaction. The payment processing system transmits the authorization via the card network.

In one example embodiment of a wallet account, payment processing systems enable users to utilize a single account to access multiple financial accounts maintained by multiple issuers. The user then associates one or more financial accounts with the wallet account. For example, the user can associate with the user's wallet account multiple debit/credit cards maintained by multiple issuers (including the payment processing system operating as an issuer), stored value cards, prepaid cards, re-loadable transaction cards, exchange cards, and other forms of non-credit based value cards), loyalty cards or other store rewards cards, value added service accounts (for example, coupons, vouchers for prepaid offers, redemption offers, and other forms of offers), peer-to-peer transaction accounts, bank accounts and/or other forms of financial accounts.

Some of the associated accounts may be open loop accounts. An open loop account may be used to purchase products at any merchant. When employing an open loop account at a merchant, the account is typically accessed over a credit card network. For example, the merchant system transmits an authorization request via the acquirer of the merchant system. The acquirer transmits the request to a card network associated with one or more major credit card companies. The card network transmits the request to the appropriate payment processing system associated with the issuer of the card.

Some accounts may be closed loop accounts that may only be used for transactions at a particular merchant or group of merchants. In one example, a “gift card” may represent a closed loop account that contains specific limitations for redemption, such as the merchant at which it may be redeemed. In a typical closed loop transaction, a redemption request is not transmitted via an acquirer and card network. The redemption request is transmitted via a direct link from the merchant to the gift card issuer and redeemed directly by the merchant system and/or the gift card issuer directly linked to the merchant.

The user sets rules or preferences specifying when the closed loop account is accessed when a wallet account transaction is attempted. For example, a user may prefer to store gift cards until a certain dollar value is reached. A user may only choose to use a gift card on a purchase that exhausts the entire gift card amount. Any other rule may be configured for using the closed loop account. The user can then add, delete, or change the default payment rules associated with the user's wallet account. The user can change these default static rules, create new rules, or delete a rule. In an example embodiment, the user can access the wallet account and modify the rules at any time, including a time immediately before a payment transaction is initiated. In an example embodiment, the user can access the wallet account using a mobile device application, such as a digital wallet application module executing on the user's mobile computing device. The rules can be maintained on the digital wallet application module, on the user computing device, or on a server at the payment processing system. Throughout the specification, any of the functions described as being performed by the digital wallet application module or the user computing device can be performed by the payment processing system. Alternatively, any functions described as being performed by the payment processing system can be performed by the digital wallet application module or the user computing device.

The wallet account can be represented on a digital wallet application module or other payment application on a user computing device, such as a mobile phone. For example, the user wallet account information, such as a wallet account identifier, can be stored on the user computing device for use in a payment transaction by the digital wallet application module or other application. The user can communicate the wallet account identifier and other transaction data to a merchant point of sale (“POS”) terminal using the user computing device via near field communication (“NFC”), barcode, BLUETOOTH, Wi-Fi communication, infrared, or other suitable communication technology. Alternatively, the wallet account can have thereto associated a physical payment card comprising a magnetic stripe or other machine-readable portion comprising the user's wallet account identifier and other payment information. In this case, the user scans or swipes the wallet account at the merchant POS terminal to communicate the wallet account identifier and other transaction data to the merchant POS terminal. Additionally or alternatively, the wallet account can be represented as any other suitable payment instrument, such as an RFID device or a smartcard. Additionally or alternatively, the payment account can be a digital wallet application module or other payment account on a user computing device for conducting online transactions, such as a mobile or desktop computer, laptop computer, or a television with one or more processors embedded therein and/or coupled thereto.

The merchant system creates an open loop payment request for the transaction using the wallet account information and forwards the payment request via an open loop architecture to an acquirer, which forwards the payment request to a card network. The card network forwards the payment request to the payment processing system, which functions as the issuer for the payment request.

The payment processing system reads wallet account information from the payment request and accesses the user's account associated with the wallet account.

The payment processing system determines the identification of the merchant system based on the data in the transaction request for from any suitable source. The payment processing system transmits a request to a gift card issuer system to determine if the user has a gift card associated with the merchant system. The request from the payment processing system may include a user identification, merchant identification, product identification, or any other suitable transaction data. The gift card issuer system may be an issuer of the gift card, a system that stores and monitors gift cards for merchant systems, a function of the merchant system, or any suitable system for storing and monitoring gift cards.

If a gift card is identified, then the gift card issuer system determines the amount available on the gift card. The gift card system 150 may transmit the available balance to the payment processing system.

The payment processing system determines if the available balance is greater than the transaction request. If the amount is greater than the entire transaction request may be conducted with the gift card funds. If the amount is less than the transaction request, then the payment processing system deducts the amount of the gift card from the transaction request. For example, if the transaction request is for $50 and a gift card has $20 available, then the payment processing system may deduct the $20 from the $50 transaction request. In this example, the payment processing system finds an alternate payment instrument for the remaining $30.

To fund any remaining portion of the transaction, the payment processing system transmits an authorization request to an alternate payment instrument. Typically, the alternate payment instrument is an open loop account, such as a credit card, debit card, or an open loop stored value card.

If the payment processing system is the issuer of the alternate financial account selected as the backing account for the wallet account transaction, the payment processing system will approve or decline the transaction.

If another issuer maintains the alternate financial account to be used as the backing account for the transaction, the payment processing system will generate and send a new payment request for the transaction to the other issuer. The payment processing system receives an authorization message from the other issuer via the card network if the transaction is approved.

The payment processing system forwards an authorization to the acquirer for the full amount of the transaction, which forwards the authorization to the merchant system. The authorization is based on the payment processing system's determination as the issuer to authorize the transaction or the authorization received from the other issuer, based on the retention of funds provided by the gift card issuer system and the authorization of funds provided by the other issuer.

The merchant system then approves the transaction, based on the authorization received from the payment processing system.

### Example System Architectures

Turning now to the drawings, in which like numerals represent like (but not necessarily identical) elements throughout the figures, example embodiments are described in detail.

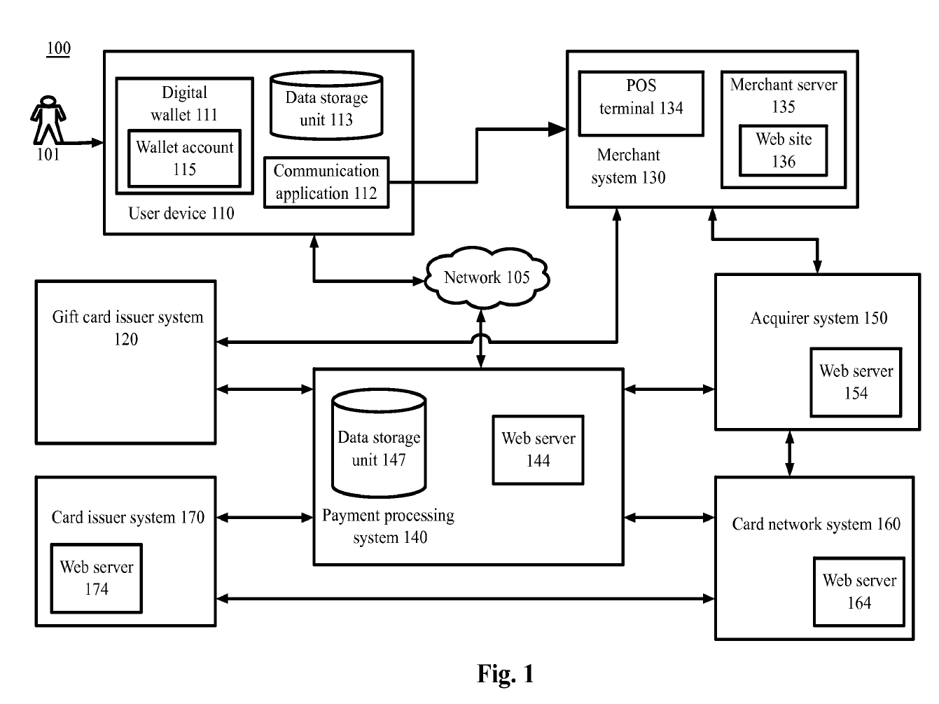

FIG. 1 is a block diagram depicting a system for redeeming closed loop payment instruments in wallet account transactions, in accordance with certain example embodiments. In some embodiments, a user associated with a device must install an application and/or make a feature selection to obtain the benefits of the techniques described herein.

As depicted in FIG. 1, the system 100 includes network computing devices 110, 120, 130, 140, 150, 160, and 170 that are configured to communicate with one another via one or more networks 105 or via any suitable communication technology.

Each network 105 includes a wired or wireless telecommunication means by which network devices (including devices 110 and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment.

Each network computing device 120, 130, 150, 160, and 170 includes a device having a communication module capable of transmitting and receiving data over the network 105 or a similar network. For example, each network computing device 120, 130, 150, 160, and 170 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 120, 130, 150, 160, and 170 are operated by end-users or consumers, gift card issuer system operators, merchant system operators, payment processing system operators, acquirer system operators, card network system operators, and card issuer system operators, respectively.

The user 101 can use the communication application 112, which may be, for example, a web browser application or a stand-alone application, to view, download, upload, or otherwise access documents or web pages via a distributed network 105. The communication application 112 can interact with web servers or other computing devices connected to the network 105, including the point of sale terminal 134 of the merchant system 130, the merchant server 135 of the merchant system 130, and the web server 144 of the payment processing system 140.

The user network device 110 may include a digital wallet application module 111. The digital wallet application module 111 may encompass any application, hardware, software, or process the user computing device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112.

The user computing device 110 can include a wallet account application 115. The wallet account application 115 can interact with the communication application 112 or be embodied as a companion application of the communication application 112 and execute within the communication application 112. The wallet account application 115 may further be embodied as a companion application of the digital wallet application module 111 and execute within the digital wallet application module 111. The wallet account application 115 may employ a software interface for configuration that may open in the digital wallet application module 111 or may open in the web browser application 112. Alternatively, the wallet account application 115 may execute on the user computing device 110 independent of the digital wallet application module 111 and the communication application 112.

The wallet account application 115 is operable to allow a user 101 to configure a wallet account on the user computing device 110 and the payment processing system 140. The wallet account application 115 can allow the user 101 to set rules, confirm transactions, select preferred accounts for a transaction, receive notice of a account selection, and provide other suitable services. Any functions of the wallet account application 115 can be performed by the digital wallet application module 111. Any function of the digital wallet application 111 can be performed by the wallet account application 115. Additionally or alternatively, any function of the wallet account application 115 and the digital wallet application module 111 can be performed by the payment processing system 140.

The user computing device 110 also includes a data storage unit 113 accessible by the digital wallet application module 111, the wallet account application 115, and the communication application 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory.

The user 101 may use the user computing device 110 or other network device to register the wallet account application 115 and/or access the payment processing system account of the user 101. The user computing device 110 may comprise appropriate technology that includes or is coupled to a web server.

The wallet account or other payment account can have thereto associated a magnetic strip card. The magnetic stripe card can be a physical payment card comprising a magnetic stripe or other machine-readable portion comprising the user's wallet account identifier and other payment information. In this case, the user scans or swipes the magnetic stripe card at the merchant POS terminal 134 to communicate the wallet account identifier and other transaction data to the POS terminal 134. Additionally or alternatively, the wallet account can have thereto associated any other suitable payment instrument, such as an RFID device or a smartcard.

The payment processing system 140 includes a data storage unit 147 accessible by the web server 144. The example data storage unit 147 can include one or more tangible computer-readable storage devices. The payment processing system 140 is operable to conduct wireless payments between a user 101 and a merchant system 130. The payment processing system 140 is further operable to maintain a database to store transactions of the merchant system 130 and the user 101, recommend automatic payment recipients, and other suitable functions.

The user 101 can use a web server 144 on the payment processing system 140 to view, register, download, upload, or otherwise access the payment processing system 140 via a website (not illustrated) and a communication network 105). The user 101 associates one or more registered financial accounts, including bank account debit cards, credit cards, gift cards, loyalty cards, coupons, offers, prepaid offers, store rewards cards, or other type of financial account that can be used to make a purchase or redeem value-added services with a payment account of the user 101. The card issuer system 170 may be the issuer of the financial account being registered. For example, the card issuer system 170 may be a credit card issuer, a debit card issuer, a stored value issuer, a financial institution providing an account, or any other provider of a financial account. The payment processing system 140 also may function as the issuer for the associated financial account. The user's 101 registration information is saved in the payment processing system's 140 data storage unit 147 and is accessible the by web server 144. The user 101 also may use the web server 144 to define payment rules.

The user 101 may request a purchase from the merchant system 130. In an example embodiment, the purchase is initiated by a wireless “tap” of the mobile device 110 with the POS terminal 134. In an alternative example embodiment, the purchase is initiated when the user 101 enters an account identification number at the POS terminal 134 or in the mobile device 110. In another alternative example embodiment, the purchase is initiated online with the merchant server 135. The purchase may be initiated via a merchant website 136. In yet another alternative example embodiment, the purchase is initiated by use of a permanent/temporary virtual/physical token, QR code, bar code, or other suitable machine-readable medium captured by the POS terminal 134. The merchant's POS terminal 134 may interact with an acquirer system 150, the card network system 160, the payment processing system 140, and the card issuer system 170.

The POS terminal 134 may be separate and distinct from the merchant server 135. The merchant server 135 can be a server located at a physical location of the POS terminal 134 or in a remote location. The POS terminal 134 can communicate transaction information with the merchant server 135 in circumstances where it would be advantageous for transaction storage or for any suitable reason. In an example, the POS terminal 134 is utilized for transactions at a physical location and the merchant server is utilized for online transactions. In another example, the POS terminal 134 and the merchant server 135 are logically connected to each other and are both utilized for a transaction at a location of a merchant system 130. In another example, the POS terminal 134 conducts all transactions at a location of a merchant system 130 and no merchant server 135 is utilized.

The acquirer system 150 represents the acquiring bank that processes credit and or debit card payments for products or services for a merchant system 130. The acquirer system 150 accepts or acquires credit card payment from the card-issuing banks within an association. The acquirer system 150 may employ a web server 154 for maintaining merchant system 150 accounts, receiving transaction requests, identifying associated payment accounts, communicating with the card network system 160, and other functions required to perform the role of acquiring bank for the merchant system 130. The acquirer system 150 requests authorizations for transactions from the card network system 160.

The card network system 160 represents an association of card-issuing banks that set transaction terms for merchants, card-issuing banks, and acquiring banks. The card network system 160 may receive an authorization request from the acquirer system 150 and process the transaction. In an example, the card network system 160 may request an authorization from a card issuer system 170 or a payment processing system 140 acting as a card issuer. The card network system 160 identifies the card issuer system 170 of the card that was used to request the transaction. The card network system 160 may employ a web server 164 for maintaining card issuer system 170 accounts, receiving transaction requests, providing authorizations, conducting transactions, and other functions required to perform the role of a card network system 160.

The card issuer system 170 may employ a web server 174 for maintaining card issuer system 170 accounts, receiving transaction requests, providing authorizations, conducting transactions, and other functions required to perform the role of a card network system 160. The role of the card issuer system 170, in certain embodiments, is performed by the payment processing system 140.

The system using a card network system 160, and acquirer system 150, a card issuer system 170, and/or a payment processing system 140, is collectively an open loop system. Open loop transactions may employ some or all of the systems 140, 150, 160, and 170 to conduct transactions.

The gift card system 120 represents a third party that manages gift cards for merchant system 130 and users 101. The gift card system 120 receives and stores gift cards associated with merchants and users. For example, if a department store sells or provides a gift card to a user 101, the user 101 enters the details of the gift card to the gift card system 120. The gift card system 120 stores the gift card details in an account of the user 101. Upon request the gift card system 120 provides an authorization to another entity to redeem the gift card if the rules and requirements are met. The gift card system 120 may further remit the funds represented by the gift card to the requester.

The system using the gift card system 120, a merchant system 120, and/or a payment processing system, is collectively a closed loop system. That is, the transactions are conducted away from the credit card network system 160 and the closed loop system places limits on the transaction. The limits may include the merchant system 120 at which the gift cards may be used, the products that may be purchased, an expiration date for the gift card, or any suitable limit.

It will be appreciated that the network connections shown are example and other means of establishing a communications link between the computers and devices can be used. Moreover, those having ordinary skill in the art having the benefit of the present disclosure will appreciate that the gift card system 120, merchant system 130, payment processing system 140, the acquirer system 150, the card network system 160, the financial account issuer 170, and the user computing device 110 illustrated in FIG. 1 can have any of several other suitable computer system configurations. For example a user computing device 110 embodied as a mobile phone or handheld computer may not include all the components described above.

### Example Processes

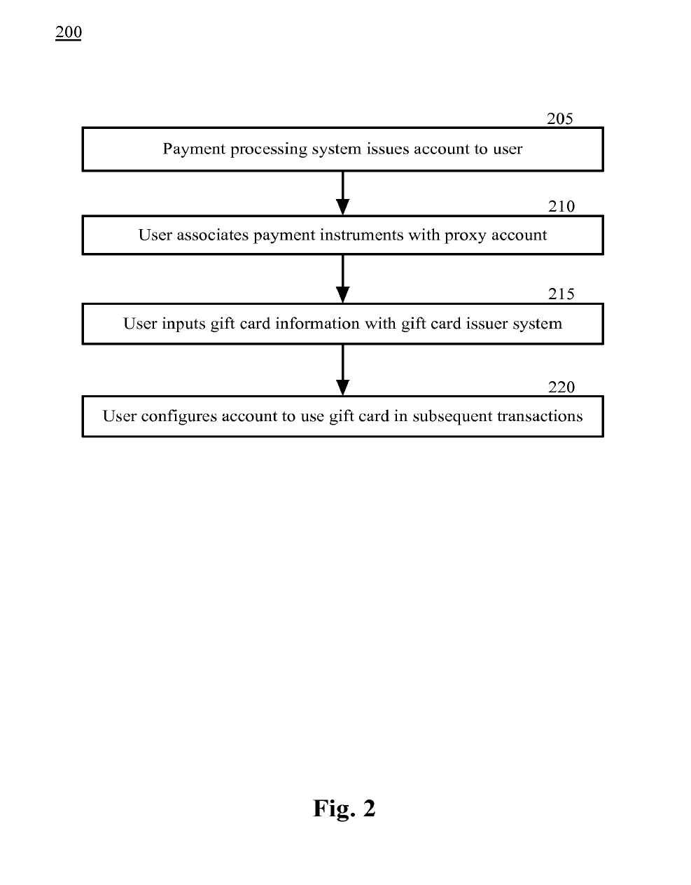

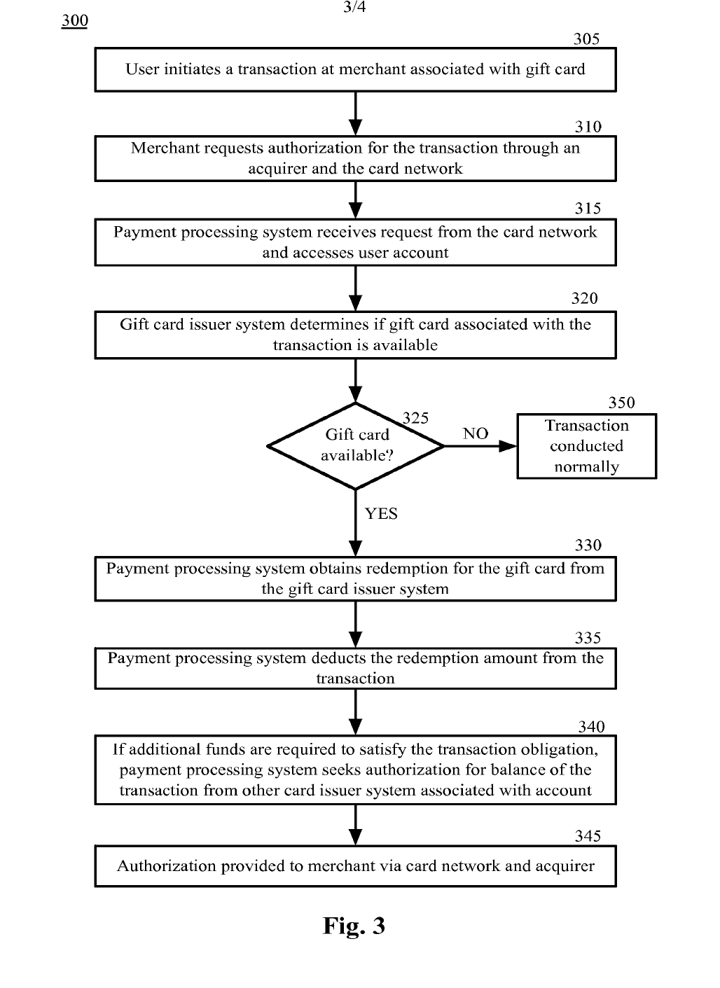

The example methods illustrated in FIGS. 2-3 are described hereinafter with respect to the components of the example operating environment 100 illustrated in FIG. 1. The example methods of FIGS. 2-3 may also be performed with other systems and in other environments.

FIG. 2 is a block flow diagram depicting a method 200 to configure payment instruments in a payment account on a payment processing system, in accordance with certain example embodiments.

With reference to FIGS. 1 and 2, in block 205, the payment processing system 140 issues a wallet account to a user 101. In one example embodiment of a wallet account, a payment processing system 140 enables users to utilize a single account to access multiple financial accounts maintained by multiple card issuer systems 170. The user 101 receives a wallet account from the payment processing system 140 and either creates a new wallet account with the payment processing system 140 or associates the wallet account with the user's digital wallet already maintained by the payment processing system 140. The user 101 establishes a user identification for the wallet account.

In block 210, the user 101 associates one or more financial accounts with the wallet account. For example, the user 101 can associate with the user's wallet account multiple debit/credit cards maintained by multiple issuers (including the payment processing system 140 operating as an issuer), stored value cards (for example, gift cards, prepaid cards, re-loadable transaction cards, exchange cards, and other forms of non-credit based value cards), loyalty cards or other store rewards cards, value added service accounts (for example, coupons, vouchers for prepaid offers, redemption offers, and other forms of offers), peer-to-peer transaction accounts, bank accounts and/or other forms of financial accounts.

Some of the associated accounts may be open loop accounts. An open loop account may be used to purchase products at any merchant. When employing an open loop account at a merchant system 130, the account is typically accessed over a credit card network system 150. For example, the merchant system 130 transmits an authorization request via the acquirer system 150 of the merchant system 130. The acquirer system 150 transmits the request to a card network system 150 associated with one or more major credit card companies. The card network system 150 transmits the request to the appropriate payment processing system 140, to a card issuer system 170, or to any suitably institution.

Some accounts may be closed loop accounts that may only be used for transactions at a particular merchant system 130 or group of merchant systems. In one example, a “gift card” is a form of closed loop account that contains specific limitations for redemption, such as the merchant at which it may be redeemed. In a typical closed loop transaction, a redemption request is not transmitted via an acquirer system 150 and card network system 150. The redemption request is transmitted via a direct link between the merchant and the gift card issuer, or redeemed directly by the merchant system acting as the gift card issuer.

In block 215, the user 101 inputs gift card information with the gift card issuer system 120. In an example, a user 101 establishes an account at a gift card issuer system 120. The user 101 establishes a user identification for the account. The user identification may be the same user identification as the user identification from the wallet account. If a department store sells or provides a gift card to a user 101, the user 101 enters the details of the gift card to the gift card system 120. The gift card system 120 stores the gift card details in an account of the user 101. In another example, the user 101 purchases the gift card directly from the gift card system 120, such as via an online purchase. The gift card may be provided to the gift card system 120 in any suitable manner. The gift card information may be input to the gift card system in any suitable manner. For example, the information may be entered by the user 101 on a website of the gift card system 120 or scanned with a camera on a user computing device 110.

In block 220, the user 101 configures the wallet account to use the gift card account in subsequent transactions. The user 101 sets rules or preferences specifying when the closed loop account is accessed when a wallet account transaction is attempted. For example, a user 101 may prefer to store gift cards until a certain dollar value is reached. A user 101 may only choose to use a gift card on a purchase that exhausts the entire gift card amount. Any other rule may be configured for using the closed loop account. The user 101 can then add, delete, or change the default payment rules associated with the user's wallet account. The user 101 can change these default static rules, create new rules, or delete a rule. In an example embodiment, the user 101 can access the wallet account and modify the rules at any time, including a time immediately before a payment transaction is initiated. In an example embodiment, the user 101 can access the wallet account using a mobile device application, such as a digital wallet application module executing on the user's mobile computing device. The rules can be maintained on the digital wallet application module 111, on the wallet account application 115, on the user computing device 110, or on a server at the payment processing system 140. Throughout the specification, any of the functions described as being performed by the digital wallet application module 111, the wallet account application 115, or the user computing device 110 can be performed by the payment processing system 140 or any suitable system or device. Alternatively, any functions described as being performed by the payment processing system 140 can be performed by the digital wallet application module 111, the wallet account application 115, or the user computing device 110.

FIG. 3 is a block flow diagram depicting a method 300 to redeem closed loop payment instruments in wallet account transactions, in accordance with certain example embodiments.

In block 300, a user 101 initiates a transaction at merchant system 130 associated with a gift card of the user 101.

The wallet account used to conduct the transaction may be represented on a digital wallet application module or other payment application on a user computing device 110, such as a mobile phone. For example, the user wallet account information, such as a wallet account identifier, can be stored on the user computing device 110 for use in a payment transaction by the digital wallet application module or other application. The user 101 can communicate the wallet account identifier and other transaction data to a merchant point of sale (“POS”) terminal 134 using the user computing device 110 via near field communication (“NFC”), barcode, BLUETOOTH, Wi-Fi communication, infrared, or other suitable communication technology. Alternatively, the wallet account can have thereto associated a physical payment card comprising a magnetic stripe or other machine-readable portion comprising the user's wallet account identifier and other payment information. In this case, the user 101 scans or swipes the wallet account card at the merchant POS terminal 134 to communicate the wallet account identifier and other transaction data to the merchant POS terminal 134. Additionally or alternatively, the wallet account can be represented as any other suitable payment instrument, such as an RFID device or a smartcard. Additionally or alternatively, the payment account can be a digital wallet application module 111 or other payment account on a user computing device 110 for conducting online transactions, such as a mobile or desktop computer, laptop computer, or a television with one or more processors embedded therein and/or coupled thereto.

In block 310, the merchant system 130 requests authorization for the transaction through an acquirer system 150 and the card network system 160. The transaction is initiated as a conventional open loop transaction via the credit card architecture as described herein. The merchant system 130 creates a payment request for the transaction using the wallet account information and forwards the authorization request to an acquirer system 150, which forwards the authorization request to a card network system 150. The card network system 150 identifies the payment processing system 140 as the issuer of the wallet account associated with the account identifier provided to the merchant system 130. The card network system 150 forwards the authorization request to the payment processing system 140, which functions as the issuer for the payment request.

In block 315, the payment processing system 140 receives the authorization request from the card network system 160 and accesses the user account. The payment processing system 140 reads wallet account information from the payment request and accesses the user's account associated with the wallet account.

In block 320, the gift card issuer system 120 determines if a gift card associated with the transaction is available. In an example, the payment processing system 140 determines the identification of the merchant system 130 based on the data in the transaction request for from any suitable source. The payment processing system 140 determines the user identification for the wallet account and the user identification for the user account on the gift card issuer system 120. The payment processing system 140 transmits a request to a gift card issuer system 120 to determine if the user 101 has a gift card associated with the merchant system 130. The request includes the user identification for the user account on the gift card issuer system 120, identification of the merchant system 120, and identification of a product being purchased, or any other suitable information. The gift card issuer system 120 may be an issuer of the gift card, a system that stores and monitors gift cards for merchant systems, or a function of the merchant system 130.

In block 325, if a gift card is available for the pending transaction, then the method 300 proceeds to block 330. If a gift card is not available for the pending transaction, then the method 300 proceeds to block 350.

In block 350, the transaction is conducted in a traditional manner. That is, a gift card associated with the gift card system 120 is not used to fund any portion of the transaction. The transaction may be funded by one or more of the open loop or closed loop accounts that are not associated with the gift card system 120.

Returning to block 330, the payment processing system 140 obtains a redemption for the gift card from the gift card issuer system 120. If a gift card is identified, then the gift card system 120 determines the amount available on the gift card. The gift card system 150 may transmit the available balance to the payment processing system 140. Typically, if the transaction request is less than the amount available on the gift card, only the amount of the transaction request is redeemed. The gift card system 150 transmits a redemption authorization for the pending transaction.

In block 335, the payment processing system 140 deducts the redemption amount from the transaction. The payment processing system 140 determines if the available balance is greater than the transaction request. If the balance is greater than the entire transaction request, then the entire transaction may be conducted with the gift card funds. If the balance is less than the transaction request, then the payment processing system 140 deducts the amount of the gift card from the transaction request. For example, if the transaction request is for $50 and a gift card has $20 available, then the payment processing system 140 may deduct the $20 from the $50 transaction request. In this example, the payment processing system 140 finds an alternate payment account for the remaining $30.

In block 340, if additional funds are required to satisfy the transaction request, the payment processing system 140 seeks authorization for the balance of the transaction from another card issuer system 170 associated with account. To fund any remaining portion of the transaction, the payment processing system 140 transmits an authorization request to an alternate payment account issuer. Typically, the alternate payment instrument is an open loop account, such as a credit card, debit card, or an open loop stored value card.

If the payment processing system 140 is the issuer of the alternate financial account selected as the backing account for the wallet account transaction, the payment processing system 140 will approve or decline the transaction for the remaining amount required to fund the original transaction.

If another card issuer system 170 maintains the alternate financial account to be used as the backing account for the transaction, the payment processing system 140 will generate and send a new payment request for the transaction to the card issuer system. The payment processing system 140 receives an authorization message from the other issuer if the transaction is approved.

In block 345, an authorization is provided to merchant system 130 via the card network system 160 and the acquirer system 150 for the full amount of the original transaction request, based on the authorization for the gift card redemption and the authorization for the alternate financial account, if necessary. The payment processing system 140 forwards an authorization to the card network system 150. The card network system forwards the authorization to the acquirer system 150, which forwards the authorization to the merchant system 130. The authorization is based on the determination of the payment processing system 140 to authorize the transaction.

The merchant system 130 then approves the transaction, based on the authorization received from the payment processing system 140. The payment processing system 140 reconciles the payment with merchant system 130 such that the merchant system 130 receives payment for the entire amount transaction. The payment processing system 140 will receive funds from the gift card issuer system 120 equal to the amount authorized from the gift card issuer system 120. The payment processing system 140 additionally receive funds from the alternate payment account equal to the amount authorized from the alternate payment account.

### Example Systems

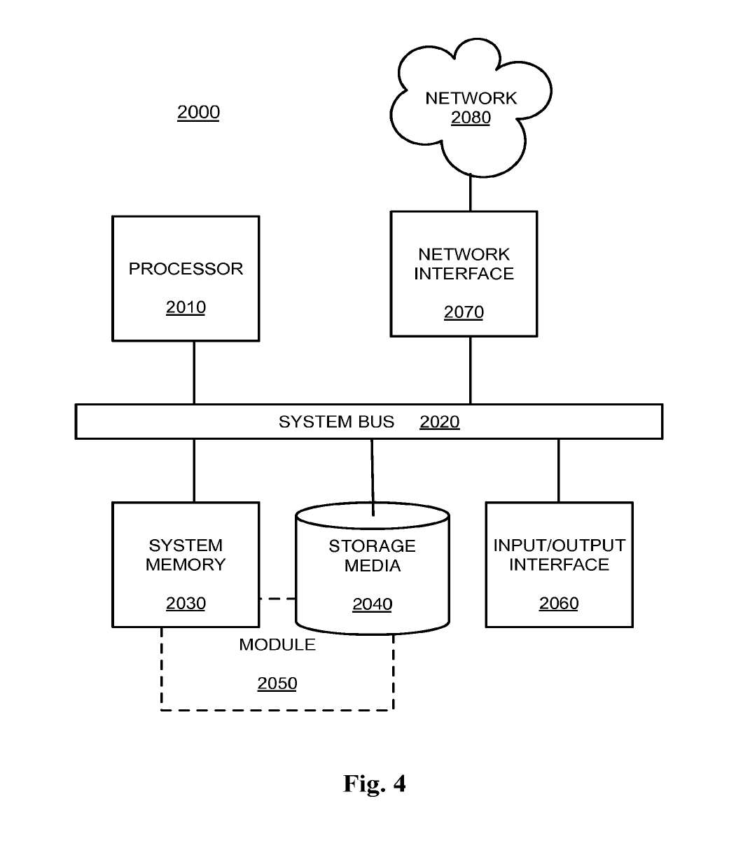

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to process combined transactions comprising redemptions of both closed loop payment instruments and open loop payment instruments in response to receiving open loop payment requests originating from merchant computing systems, comprising:
associating, using one or more computing devices, a plurality of financial accounts with a payment account of a user, the plurality of financial accounts comprising at least a closed loop account and an open loop account, wherein the payment account comprises a payment account identifier associated therewith;
receiving from an open loop processing system, using the one or more computing devices, a first payment authorization request originating from a merchant computing system separate from the open loop processing system, the first payment authorization request comprising the payment account identifier, a request to fund a transaction for the purchase of goods or services using the payment account, a total amount of the transaction, and an indication of an identity of a merchant associated with the merchant computing system;
communicating, using the one or more computing devices and to a closed loop account issuer computing system associated with the closed loop account, a redemption request to redeem funds from the closed loop account associated with the payment account, the redemption request comprising information from the first payment authorization request;
receiving, using the one or more computing devices and from the closed loop account issuer computing system, a redemption of funds deducted from the closed loop account associated with the payment account;
deducting, using the one or more computing devices, the funds redeemed from the closed loop account from the total amount of the transaction to obtain a remaining amount of funds required to fund the transaction;
identifying, using the one or more computing devices, the open loop account associated with the payment account to use as a backing financial account for the remaining amount of funds required to fund the transaction;
communicating, using the one or more computing devices and to an open loop account issuer computing system associated with the open loop account associated with the payment account, a second payment authorization request comprising a request for the remaining amount of funds required to fund the transaction;
receiving, using the one or more computing devices and from the open loop account issuer computing system, a first authorization for the remaining amount of funds required to fund the transaction from the open loop account associated with the payment account; and
in response to receiving both the redemption of funds deducted from the closed loop account and the first authorization for the remaining amount of funds required to fund the transaction from the open loop account issuer computing system, communicating, using the one or more computing devices, to the merchant computing system, a second authorization authorizing the total amount requested in the first authorization request.

2. The computer-implemented method of claim 1, wherein the closed loop account is funded by one or more gift cards associated with the merchant computing system.

3. The computer-implemented method of claim 1, wherein the redemption request comprises information that allows the closed loop account issuer computing system to identify the merchant computing system.

4. The computer-implemented method of claim 1, wherein the transaction comprises an online transaction.

5. The computer-implemented method of claim 1, wherein the redemption of funds is received from the closed loop account upon a determination that the merchant associated with the merchant computing system is associated with the closed loop account.

6. The computer-implemented method of claim 1, wherein the funds redeemed from the closed loop account issuer are only received from the closed loop account issuer computing system if a configured set of conditions are met.

7. A computer program product, comprising:
a non-transitory computer-readable storage device having computer-executable program instructions embodied thereon that when executed by a computer cause the computer to redeem closed loop payment instruments in open loop wallet account transactions, the computer-executable program instructions comprising:
computer-executable program instructions to associate a plurality of financial accounts with a payment record of a user, the plurality of financial accounts comprising a closed loop account and an open loop account, and the payment record having a payment record identifier associated therewith;
computer-executable program instructions to receive, from an open loop card network, a first payment authorization request originating from a merchant computing system separate from the open loop card network, the first payment authorization request comprising the payment account identifier, a request to fund a transaction using the payment account, and an indication of an identity of a merchant associated with the merchant computing system;
computer-executable program instructions to communicate, to a closed loop account issuer computing system associated with the closed loop account associated with the payment record, a redemption request to redeem funds from the closed loop account associated with the payment record in connection with the first payment authorization request, the redemption request comprising information from the first payment authorization request;
computer-executable program instructions to receive, from the closed loop account issuer computing system, a redemption of funds from the closed loop account associated with the payment record, the funds being deducted from the closed loop account associated with the payment record;
computer-executable program instructions to deduct the funds redeemed from the closed loop account issuer computing system from a total amount of funds requested in the first payment authorization request to obtain a remaining amount of funds required to fund the transaction; and
computer-executable program instructions to communicate to the merchant computing system a second authorization for the total amount of funds requested in the first authorization request based on the redemption of funds from the closed loop account associated with the payment account.

8. The computer program product of claim 7, the computer-executable program instructions further comprising:
computer-executable program instructions to identify a second financial account associated with the payment record to use as a backing financial account for the requested amount of funds required to fund the transaction, the second financial account being the open loop account associated with the payment record;
computer-executable program instructions to communicate to an open loop account issuer computing system associated with the open loop account associated with the payment account, a second payment authorization request comprising a request for the remaining amount of funds required to fund the transaction;
computer-executable program instructions to receive from the open loop account issuer computing system, a first authorization for the remaining amount of funds required to fund the transaction from the open loop account associated with the payment account; and
computer-executable program instructions to communicate to the merchant computing system a third authorization for the total amount of funds requested in the first authorization request based on the redemption of funds from the closed loop account associated with the payment account and the first authorization for the remaining amount of funds required to fund the transaction from the open loop account associated with the payment account.

9. The computer program product of claim 7, wherein the redemption request comprises information that allows the closed loop account issuer computing system to identify the merchant computing system.

10. The computer program product of claim 7, wherein the transaction is an online transaction.

11. The computer program product of claim 7, wherein a redemption of funds is received from the closed loop account associated with the payment record upon a determination that the merchant associated with the merchant computing system is associated with the closed loop account.

12. The computer program product of claim 7, wherein the funds redeemed from the closed loop account issuer are only received from the closed loop account issuer computing system if a configured set of conditions are met.

13. The computer program product of claim 7, wherein the closed loop account is funded by one or more gift cards associated with the merchant computing system.

14. A system to select payment accounts to redeem closed loop payment instruments in open loop wallet account transactions, the system comprising:
a storage resource; and
a processor communicatively coupled to the storage resource, wherein the processor executes application code instructions that are stored in the storage resource and that cause the system to:
associate a plurality of financial accounts with a payment account of a user, the plurality of financial accounts comprising a closed loop account and an open loop account, and the payment account having a payment account identifier associated therewith;
receive, from an open loop card network a first payment authorization request originating from a merchant computing system separate from the open loop card network, the first payment authorization request comprising the payment account identifier, a request to fund a transaction using the payment account, and an indication of an identity of a merchant associated with the merchant computing system;
communicate to a closed loop account issuer computing system associated with the closed loop account associated with the payment account, a redemption request to redeem funds from the closed loop account associated with the payment account in connection with the first payment authorization request, the redemption request comprising information from the first payment authorization request;
receive from the closed loop account issuer computing system, a redemption of funds from the closed loop account associated with the payment account, the funds being deducted from the closed loop account associated with the payment account;
deduct the funds redeemed from the closed loop account issuer computing system from a total amount of funds requested in the first payment authorization request to obtain a remaining amount of funds required to fund the transaction; and
communicate to the merchant computing system a second authorization for the total amount of funds requested in the first authorization request based on the redemption of funds from the closed loop account associated with the payment account.

15. The system of claim 14, further comprising application code instructions that are stored in the storage resource and that cause the system to:
identify a second financial account associated with the payment account to use as a backing financial account for the requested amount of funds required to fund the transaction, the second financial account being the open loop account associated with the payment account;
communicate to an open loop account issuer computing system associated with the open loop account associated with the payment account, a second payment authorization request comprising a request for the remaining amount of funds required to fund the transaction;
receive from the open loop account issuer computing system, a first authorization for the remaining amount of funds required to fund the transaction from the open loop account associated with the payment account; and
communicate to the merchant computing system a third authorization for the total amount of funds requested in the first authorization request based on the redemption of funds from the closed loop account associated with the payment account and the first authorization for the remaining amount of funds required to fund the transaction from the open loop account associated with the payment account.

16. The system of claim 14, wherein the closed loop account is funded by one or more gift cards associated with the merchant computing system.

17. The system of claim 14, wherein the redemption request comprises information that allows the closed loop account issuer computing system to identify the merchant computing system.

18. The system of claim 14, wherein the transaction is an online transaction.

19. The system of claim 14, wherein a redemption of funds is received from the closed loop account associated with the payment account upon a determination that the merchant associated with the merchant computing system is associated with the closed loop account.

20. The system of claim 14, wherein the funds redeemed from the closed loop account issuer are only received from the closed loop account issuer computing system if a configured set of conditions are met.
